(19) United States
(12) Patent Application Publication
(10) Pub. No.: US 2014/0328403 A1
(43) Pub. Date: Nov. 6, 2014

(54) IMAGE ENCODING/DECODING METHOD AND APPARATUS USING WEIGHT PREDICTION

(71) Applicant: SK TELECOM CO., LTD., Seoul (KR)

(72) Inventors: Jeongyeon LIM, Seongnam-si (KR); Joong Gunn Park, Suwon Si (KR); Joohee Moon, Seoul (KR); Haekwang Kim, Seoul (KR); Yunglyul Lee, Seoul (KR); Byeungwoo Jeon, Seongnam-si (KR); Jongki Han, Seoul (KR); Juock Lee, Seoul (KR); Mincheol Park, Bucheon-si (KR); Sungwon Lim, Seoul (KR)

(21) Appl. No.: 14/335,222

(22) Filed: Jul. 18, 2014

Related U.S. Application Data
(63) Continuation of application No. PCT/KR2013/000317, filed on Jan. 16, 2013.

(30) Foreign Application Priority Data
Jan. 20, 2012 (KR) 10-2012-0006944

(51) Int. Cl. H04N 19/44; H04N 19/463; H04N 19/577; H04N 19/105

(52) U.S. Cl. CPC H04N 19/00533; H04N 19/00024; H04N 19/00551; H04N 19/00721
USPC 375/240.16

(57) ABSTRACT

A method for decoding video images includes: determining a coding block, from a bitstream, which is divided in a quadtree structure from a largest coding block; decoding, from the bitstream, motion information on one or more prediction blocks divided from the coding block; predicting the prediction blocks based on the motion information; reconstructing a residual block from the bitstream; and reconstructing the coding block by adding the predicted prediction blocks and the reconstructed residual block. The predicting of the prediction blocks includes: generating first predicted pixels within each of the prediction blocks by using the motion information; decoding, from the bitstream, a weighted prediction parameter applicable to each of the prediction blocks; and generating second predicted pixels within each of the prediction blocks by applying the weighted prediction parameter to the first predicted pixels within each of the prediction blocks.

### CROSS-REFERENCE TO RELATED APPLICATION

The present application is a continuation of International Patent Application No. PCT/KR2013/000317, filed Jan. 16, 2013, which claims priority to Korean Patent Application No. 10-2012-0006944, filed on Jan. 20, 2012. The disclosures of the above-listed application are hereby incorporated by reference herein in their entirety.

### TECHNICAL FIELD

The present disclosure in one or more embodiments relates to video encoding/decoding apparatus and method using a weighted prediction.

### BACKGROUND

The statements in this section merely provide background information related to the present disclosure and do not constitute prior art.

MPEG (Moving Picture Experts Group) and VCEG (Video Coding Experts Group) have developed more excellent and superior video compression techniques over existing MPEG-4 Part 2 and H.263 standards. This new standard is called H.264/AVC (Advanced Video Coding) and was co-released with MPEG-4 Part 10 AVC by ITU-T Recommendation H.264.

Such a video compression scheme, when encoding the video image, partitions a picture into predetermined image processing units, for example blocks of predetermined sizes and encodes each of the blocks based on an inter-prediction or intra-prediction coding mode. At this time, an optimal coding mode is selected in consideration of the data size and the degree of distortion of the block, and the block is encoded according to the selected mode.

The inter-prediction is a method for compressing video images by removing temporal redundancy between pictures and is represented by the motion estimation coding. The motion estimation coding estimates the motion of the current picture in block unit by using at least one reference picture and predicts the respective blocks based on the result of the motion estimation.

For predicting the current block, the motion estimation coding uses a predetermined evaluation function for searching for the block most similar to the current block within a prescribed search range of the reference picture. The motion estimation coding generates a motion vector corresponding to the displacement between the current block and the most similar block searched, and the motion vector is used for motion compensation to obtain a predicted block. Residual data between the predicted block and the current block are transformed by DCT (discrete cosine transform) and then quantized. The transformed and quantized residual data and motion information are entropy-coded and transmitted and thereby increases the data compression ratio.

The motion estimation and motion compensation are performed in prediction units, and the motion information is transmitted in prediction units.

As the predicted block through the motion estimation and the compensation differs greater from the current block, the residual data has encoded bits increased to thereby deteriorate the encoding efficiency. Therefore, the inventor(s) has experienced that a motion estimation and a motion compensation are performed with improved accuracy for generating an accurately predicted block to compact the residual data.

Moreover, when using the motion estimation and motion compensation for encoding a video with temporally changing brightness such as fade in, fade out or the like, the inventor(s) has experienced that the typical inability to predict the brightness of images leads to deteriorated compression efficiency and degraded video quality.

### SUMMARY

In accordance with some embodiments of the present disclosure, a method for decoding video images comprising: determining a coding block, from a bitstream, which is divided in a quadtree structure from a largest coding block; decoding, from the bitstream, motion information on one or more prediction blocks divided from the coding block; predicting the prediction blocks based on the motion information; reconstructing a residual block from the bitstream; and reconstructing the coding block by adding the predicted prediction blocks and the reconstructed residual block. Here, the predicting the prediction blocks comprises: generating first predicted pixels within each of the prediction blocks by using the motion information; decoding, from the bitstream, a weighted prediction parameter applicable to each of the prediction blocks; and generating second predicted pixels within each of the prediction blocks by applying the weighted prediction parameter to the first predicted pixels within each of the prediction blocks.

The decoding the weighted prediction parameter decodes, from the bitstream, the weighted prediction parameter designated in a unit of slices within a picture.

The weighted prediction parameter includes information on a scale factor to multiply the first predicted pixels within the prediction blocks and information on an offset factor to add to the first predicted pixels multiplied by the scale factor.

A size of the coding block is determined variably between a size of the largest coding block and a size of a smallest coding block.

The coding block is divided into the one or more prediction blocks by one among a plurality of partition types including a partition type in which the coding block is divided into two rectangular blocks asymmetric in size.

The reconstructing of the residual block comprises: identifying one or more transform blocks partitioned in a second quadtree structure from the coding block; inversely quantizing and inversely transforming each of the transform blocks; and constructing the residual block by merging the inversely quantized and inversely transformed transform blocks.

Respective sizes of the transform blocks are determined variably based on the second quadtree within the coding unit.

The method for decoding video images may further comprise decoding a weighted prediction flag from the bitstream. The decoding of the weighted prediction parameter and the generation of the second predicted pixels is performed when the decoded weighted prediction flag indicates that a weighted prediction is applied on the prediction blocks.

The weighted prediction flag may be included in the bitstream in a unit of pictures.

### BRIEF DESCRIPTION OF DRAWINGS

FIG. 1 is a schematic block diagram of a video encoding apparatus according to at least one embodiment of the present disclosure.

FIG. 2 is an exemplary diagram of a block partitioning from a largest coding unit (LCU).

FIG. 3 is an exemplary diagram of types of prediction units.

FIG. 4 is a simplified flowchart of one of methods for calculating and applying a weighted prediction parameter according to at least one embodiment of the present disclosure.

FIG. 5 is an exemplary diagram of a method for calculating a weighted prediction parameter by using a motion compensated prediction picture in place of a reference picture.

FIG. 6 is an exemplary diagram of a method for calculating a weighted prediction parameter by using a transform.

FIG. 7 is a flowchart of a method for calculating an optimal weighted prediction flag by using, for example, multiple transform methods.

FIG. 8 is a schematic diagram of a method for obtaining a weighted parameter according to Equation 10.

FIG. 9 is an exemplary diagram illustrating frequency component weighted prediction parameters generated for respective frequency components at predetermined intervals.

FIG. 10 is a schematic diagram of a video decoding apparatus according to at least one embodiment of the present disclosure.

### DETAILED DESCRIPTION

The present disclosure in some embodiments for inter-prediction coding such as B-picture coding and P-picture coding improves the coding efficiency by encoding the current block or current picture with more accurate motion compensation performed by a weighted prediction and by decoding the current block or current picture with motion compensation performed based on weighted prediction parameter information extracted from a bitstream.

A video encoding apparatus and a video decoding apparatus to be described below are a PC (personal computer), a notebook computer, a PDA (personal digital assistant), a PMP (portable multimedia player), a PSP (PlayStation Portable), a wireless terminal, a TV set, a mobile phone, a smart phone, and the like. The video encoding apparatus and video decoding apparatus correspond to various apparatuses each including (a) a communication apparatus such as a communication modem and the like for performing communication with various types of devices or wired/wireless communication networks, (b) a memory for storing various programs and data for encoding or decoding a video, and (c) a microprocessor to execute the programs so as to perform calculations and controlling, and the likes.

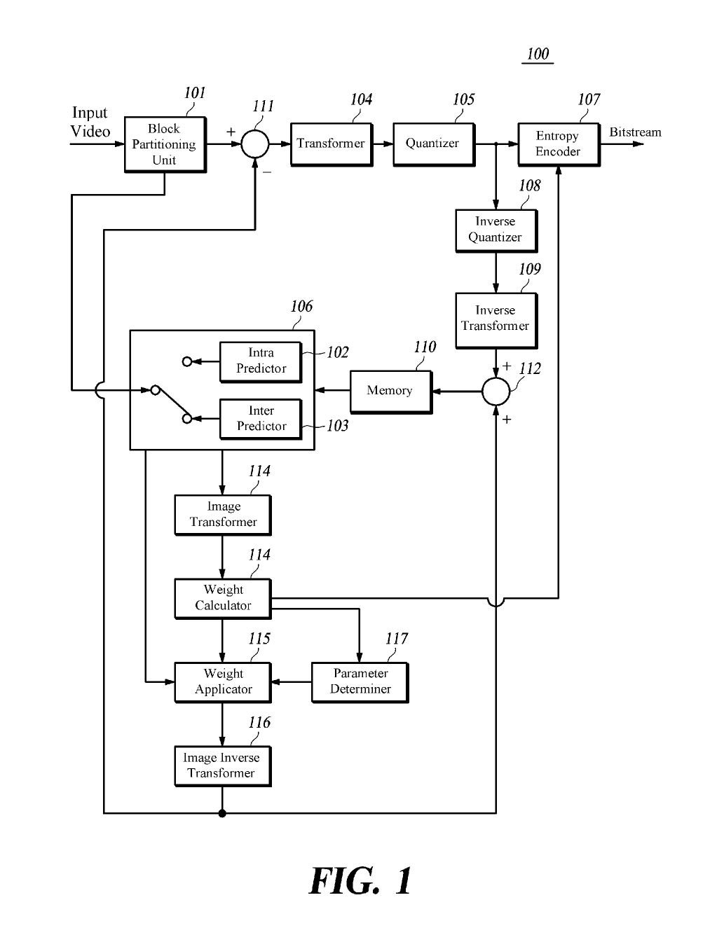

FIG. 1 is a schematic block diagram of a video encoding apparatus according to at least one embodiment of the present disclosure.

A video encoding apparatus 100 according to at least one embodiment of the present disclosure is adapted to encode video images. The video encoding apparatus 100 includes a block partitioning unit or coding tree generator 101, an intra predictor 102, an inter predictor 103, a transformer 140, a quantizer 105, an entropy encoder 107, an inverse quantizer 108, an inverse transformer 109, a memory 110, a subtractor 111, an adder 112, an image transformer 113, a weighted value calculator 114, a weighted value applicator 115 and an image inverse transformer 116. Some cases further include a parameter determiner 117. All or some components of the video encoding apparatus 100, such as the block partitioning unit or coding tree generator 101, the intra predictor 102, the inter predictor 103, the transformer 140, the quantizer 105, the entropy encoder 107, the inverse quantizer 108, the inverse transformer 109, the memory 110, the subtractor 111, the adder 112, the image transformer 113, the weighted value calculator 114, the weighted value applicator 115 and the image inverse transformer 116 are implemented by one or more processors and/or application-specific integrated circuits (ASICs).

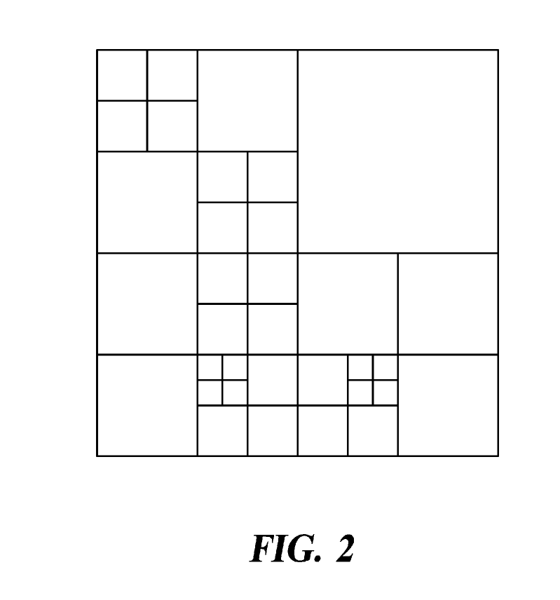

The block partitioning unit 101 partitions an input image coding units or coding blocks. The coding units or coding blocks are basic units partitioned for intra prediction/inter prediction. They have a quad-tree structure in which respective blocks are recursively partitioned into four blocks having the same size (for example, in square shapes). For example, a largest coding unit may be predetermined in size as 64×64 and a minimum coding unit may be predetermined in size as 8×8. The size of the coding block is determined to be a size ranging from a size of the largest coding block to a size of the minimum coding block, by using the quad-tree partitioning. FIG. 2 is an exemplary diagram of a block partitioning from the largest coding unit. While a quad-tree is generally used having three levels from the largest coding unit to the minimum coding unit, higher levels or depths may be used. Maximum partition depths for color components, such as luma and chroma are the same.

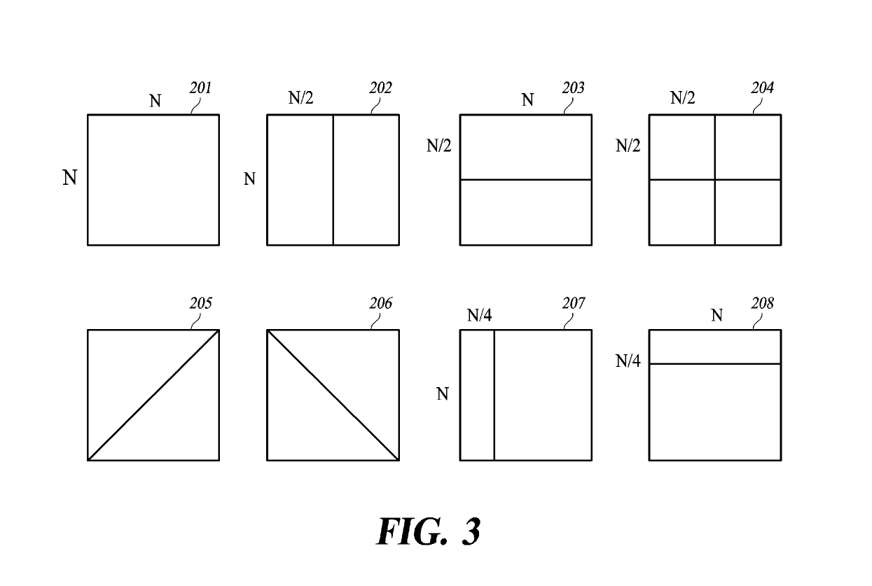

Each coding unit includes one or more prediction units or prediction blocks according to the type of prediction as illustrated in FIG. 3. The prediction unit or prediction block is the minimum unit having prediction information to generate the aforementioned predicted block. As shown in FIG. 3, reference numeral 201 indicates a case that the coding unit is used as the prediction unit as it is. Numerals 202, 203, 205 and 206 indicate cases that the coding unit is partitioned into two prediction units in the same size. Numeral 204 indicates a case that the coding unit is partitioned into four prediction units in the same size. Numerals 207 and 208 indicate cases that the coding unit is partitioned into two prediction units having 1:3 ratio in size. The coding unit is partitioned in a variety of shapes other than the illustrations in FIG. 3.

The present disclosure further includes a predictor 106 which includes an intra predictor 102 and an inter predictor 103.

The intra predictor 102 generates a predicted block of a current coding block, by using pixel values in a current picture or current frame.

The inter predictor 103 generates a predicted block of the current coding block by predicting the respective prediction blocks divided from the current coding block, based on information on one or more reference pictures that were encoded and decoded prior to encoding a current picture. For example, the prediction is performed according to methods of SKIP, merge, motion estimation and the like.

The predictor 106 has a variety of methods for performing the prediction and generates the predicted block by using the method with the optimal encoding efficiency.

Details of the intra-prediction and inter-prediction methods will not be repeated herein because they are well known in the art.

The subtractor 111 generates a residual block of the current coding block by subtracting the predicted block generated by the predictor 106 from the current coding block.

The transformer 104 transforms the residual block in transform units, to thereby generate one or more transform blocks corresponding to the transform units. The transform units are basic units used for transforming and quantizing the coding unit or coding block. The transform units are divided from the coding unit in the same manner as illustrated in FIG. 2 or in other various manners, so as to be transformed. The transformer 104 transforms the residual signals of the respective transform units into a frequency domain to generate and output the corresponding transform blocks having transform coefficients. Here, the residual signals are transformed into the frequency domain by using a variety of schemes, such as a discrete cosine transform (DCT), a discrete sine transform (DST) and a Karhunen Loeve transform (KLT). Using the schemes, the residual signals are transformed into transform coefficients in the frequency domain. To ease the convenient use of the transform schemes, a matrix calculation based on a basis vector may be used. In the matrix calculation, various transform schemes are used together, depending on the prediction scheme used to encode the predicted block. For example, in the intra prediction, the discrete cosine transform is used in the horizontal direction and the discrete sine transform is used in the vertical direction, depending on the intra prediction modes.

The quantizer 105 quantizes the transform blocks and generates quantized transform blocks. In other words, the quantizer 105 quantizes transform coefficients of the respective transform blocks output from the transformer 104, and generates and outputs the quantized transform blocks having quantized transform coefficients. Here, while the quantizing method is a dead zone uniform threshold quantization (DZUTQ) or a quantization weighted matrix (QWM), a variety of quantizing methods are used including their improved quantization methods.

The entropy encoder 107 encodes the quantized transform blocks and output a bitstream. That is, the entropy encoder 107 scans the quantized transform coefficients of the respective quantized transform blocks outputted from the quantizer 105 into a transform coefficient stream by using a variety of scanning schemes such as a zigzag scan illustrated in FIG. 12, and encodes the stream by using a variety of encoding schemes such as an entropy encoding. The entropy encoder 107 generates and outputs the bitstream including additional information (for example, information on the prediction mode, quantization parameter, motion parameter, information on the division of the largest coding unit into one or more coding units by a quad-tree, information on the division of a coding unit into one or more transform units by a quad-tree, etc.) used to decode the relevant block in the video decoding apparatus to be described below.

Through the aforementioned process, the various prediction methods are used to perform predicting and encoding, and then the predicted block is generated by using the method with the best coding efficiency. Predicted blocks so generated are collected altogether in the unit of predetermined block groups to calculate a weighted prediction parameter which is then applied to the predicted blocks, thereby generating weighted predicted blocks. Here, the predetermined block groups are a single block, unit area for prediction, coding unit as encoding and decoding unit, group of any number of blocks, M×N block unit, slice, sequence, picture, group of pictures (GOP) or the like. A process of generating the predicted block using the weighted prediction parameter is as follows.

The weighted prediction method is classified into an explicit mode of prediction and an implicit mode of prediction. The explicit mode of prediction is for calculating the weighted prediction parameter in units of slice to generate and transmit an optimal weighted prediction parameter for each slice to the decoding apparatus. The implicit mode of prediction, does not calculate and encode the weighted prediction parameter. In the implicit mode, the weight is calculated by the temporal distance between the current image and the reference image by using the same method agreed between the encoding apparatus and decoding apparatus.

The inter predictor 103 includes a motion compensator which performs a motion compensation for a current prediction unit by using a motion vector of the current prediction unit to generate a predicted block. At this time, the image encoding apparatus generates the predicted block from reference picture by using a motion vector. At least one embodiment of the present disclosure generates a weighted predicted block by using a weighted prediction of Equation 1.

P′=w×P+o Equation 1

Here, P denotes predicted pixels within the prediction block generated from the reference picture by using the motion vector, w is a scale factor to multiply the predicted pixels of the prediction block and indicates the ratio between the predicted blocks and the weighted predicted blocks, o is an offset factor to add to the predicted pixels multiplied by the scale factor and indicates the difference between the weighted predicted block and the motion compensated predicted block used for the weighted prediction, and P′ is weighted predicted pixels of the weighted predicted block.

Here, the weighted prediction parameter includes information on the scale factor and offset factor. This weighted prediction parameter is determined and encoded in arbitrary units. The arbitrary units in this case includes sequence, picture and slice. For example, an optimal weighted prediction parameter is determined in units of slice, and in case of explicit mode, the optimal one is encoded onto the slide header or an adaptive parameter header. The decoding apparatus generates the weighted predicted block by using weighted prediction parameter extracted from the corresponding header.

Further, Equation 1 applies when a unidirectional inter prediction is performed, and when performing a bidirectional prediction, the weighted predicted block is generated by using Equation 2.

P′=((w₀×P₀+o₀)+(w₁×P₁+o₁))/2 Equation 2

Here, P₀ denotes predicted pixels generated by using a list 0 reference picture and a list 0 motion vector, w₀ is a scale factor to apply to the predicted pixels P₀, o₀ is an offset factor to apply to the predicted pixels P₀, P₁ is predicted pixels generated by using a list 1 reference picture and a list 0 motion vector, w₁ is a scale factor to apply to the predicted pixels P₁, o₁ is offset factor to apply to the predicted pixels P₁, and P′ is weighted predicted pixels. In the case of the bidirectional prediction, an optimal weighted prediction parameter for each of list 0 and list 1 predictions can be calculated, and in explicit mode, the optimal ones are encoded onto an arbitrary header.

In addition, Equation 3 is used to generate the weighted predicted block for the purpose of bidirectional prediction.

P′=(w₀×P₀+w₁×P₁)/2+(o₀+o)/2 Equation 3

Further, Equation 4 is used to generate the weighted predicted block for bidirectional prediction.

P′=w×(P+)/2+o Equation 4

In this case, with the weighted prediction parameter applied to an average predicted block which means an average of predicted blocks generated respectively from list 0 and list 1 predictions, a weighted predicted block is generated. At this time, the weighted prediction parameter for each of list 0 and list 1 predictions is not calculated, but the optimal weighted prediction parameter for the average predicted block is calculated.

Alternatively, Equation 5 is used to generate the weighted predicted block for bidirectional prediction.

P′=(w₀×P₀+w₁×P₁)/2+o Equation 5

In this case, as the scale factor for use in the weighted prediction, an optimal scale factor for each of list 0 and list 1 predictions is calculated and encoded, and as an offset factor an optimal one for the average predicted block is calculated and encoded.

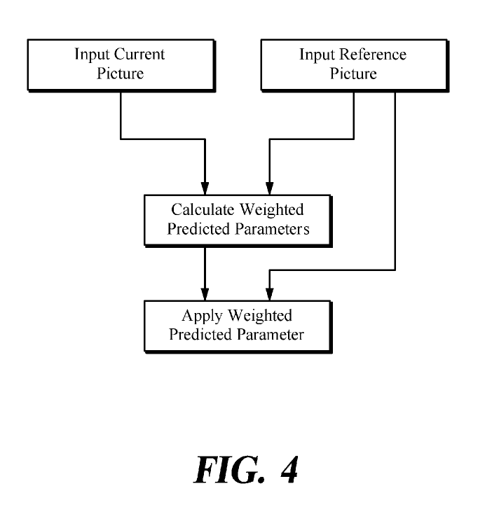

FIG. 4 is a simplified flowchart of one of methods for calculating and applying a weighted prediction parameter according to at least one embodiment.

Referring to FIG. 4, with the use of the current picture to encode and the reference picture, a weighted prediction parameter is calculated. For generating an optimal weighted prediction parameter, at least one embodiment uses a variety of methods. For example, Equation 6 is used to calculate the weighted prediction parameter.

$$w = {\sum }_{n = 0}^{N - 1} \frac{org ( n )}{ref ( n )} \\ o = {\sum }_{n = 0}^{N - 1} org ( n ) - {\sum }_{n = 0}^{N - 1} ref ( n ) \qquad Equation 6$$

In Equation 6, org(n) denotes the n-th pixel of the current picture to be encoded, ref(n) the n-th pixel of the reference picture, and N the number of pixels in the picture.

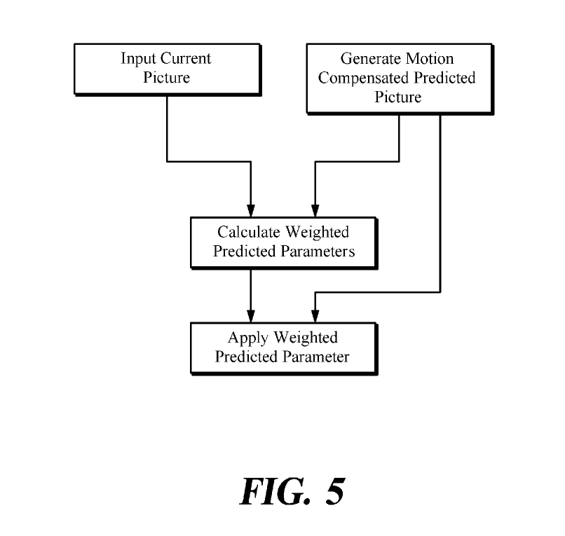

FIG. 5 is an exemplary diagram of a method for calculating a weighted prediction parameter by using a motion compensated prediction picture in place of the reference picture.

As shown in FIG. 5, at least one embodiment calculates a weighted prediction parameter with a motion compensated prediction picture replacing the reference picture. Here, the motion compensated prediction picture is generated by predicted blocks after motion compensation.

The case of FIG. 5 calculates the weighted prediction parameter with Equation 7.

$$w = {\sum }_{n = 0}^{N - 1} \frac{org ( n )}{mcp ( n )} \\ o = {\sum }_{n = 0}^{N - 1} org ( n ) - {\sum }_{n = 0}^{N - 1} mcp ( n ) \qquad Equation 7$$

In Equation 7, org(n) denotes the n-th pixel of the current picture to be encoded, mcp(n) the n-th pixel of the motion compensated prediction picture, and N the number of pixels in the picture.

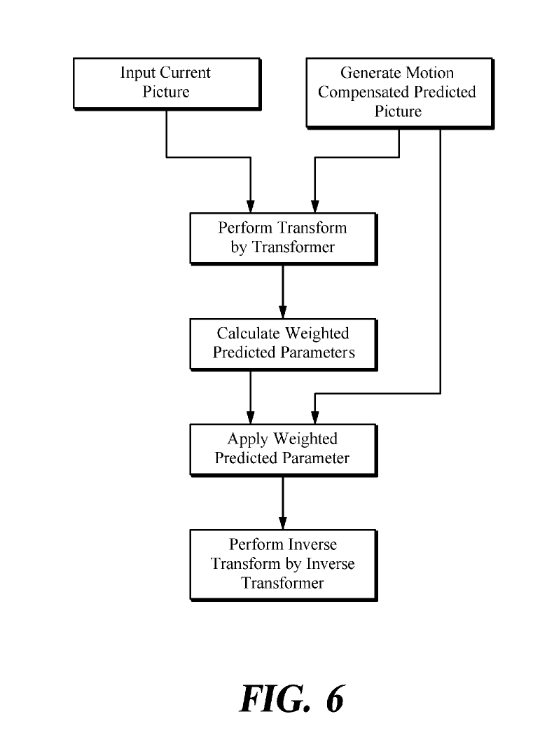

FIG. 6 is an exemplary diagram of a method for calculating a weighted prediction parameter by using a transform.

In FIG. 6, the function of a transformer can be performed by the image transformer 113.

The image transformer 113 first generates a first transformed image such as a first transformed picture by transforming a set of blocks inclusive of current block, e.g., current picture, in predetermined transform unit. In addition, the image transformer 113 generates a second transformed image such as a second transformed picture by transforming, in predetermined transform unit, a motion compensated predicted image, e.g., a motion compensated predicted picture which is a picture comprised of predicted blocks generated by predicting all blocks within the current picture. Here, the predetermined transform unit is any one of various transform units such as 8×8 or 4×4.

Here, the image transformer 113 uses a DCT, DST, Hadamard, KLT (Karhunen-Loeve transform) and other techniques for transforming the current picture and the reference picture for each M×N block. M and N are the same or different each other.

The weight calculator 114 calculates the weighted prediction parameter for each of predetermined transform units colocated in the first and second transformed pictures based on the relationship between the transform coefficients of the first transformed picture and those of the second transformed picture. Here, the weighted prediction parameter calculation in the transform domain uses Equation 8.

$$w ( m , n ) = \frac{{\sum }_{k = 0}^{K - 1} {ORG}_{k} ( m , n ) {MCP}_{k} ( m , n )}{{\sum }_{k = 0}^{K - 1} {MCP}_{k} ( m , n ) {MCP}_{k} ( m , n )} \\ o ( m , n ) = \frac{1}{K} {\sum }_{k = 0}^{K - 1} {ORG}_{k} ( m , n ) - {MCP}_{k} ( m , n ) \qquad Equation 8$$

Here, w(m, n) is the scale factor for the frequency coefficient at position (m, n) in the M×N transform block, ORGₖ(m, n) the frequency coefficient of the k-th transform block at (m, n) in the current picture, MCPₖ(m, n) the frequency coefficient of the k-th transform block at (m, n) in the motion compensated predicted picture, and o(m, n) the offset factor for the frequency coefficient at (m, n) in the M×N transform block. As for the offset factor, it is applied only to frequency coefficient at (0, 0), which is low frequency coefficient and most sensitive in the transform domain to the human eyes.

Further, the weighted prediction can be carried out in arbitrary units. For example, the weighted prediction is performed on all pixels in picture units or in slice units. In this case, a weighted prediction flag is encoded and decoded in the arbitrary unit. For example, when encoding/decoding the weighted prediction flag for each prediction unit, the flag indicates whether to apply the weighted prediction to the corresponding predicted block.

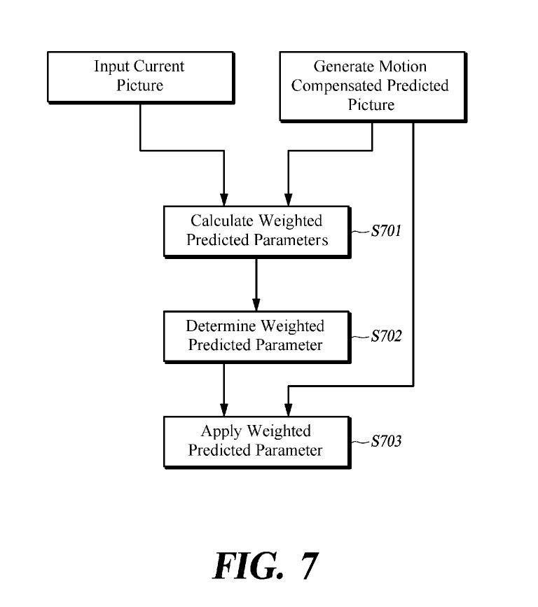

FIG. 7 is a flowchart of a method for calculating an optimal weighted prediction flag by using, for example, multiple transform methods.

When the image transformer 113 transforms by applying multiple transform algorithms and thereby the weight calculator 114 calculates a plurality of weighted prediction parameters in step S701, the parameter determiner 117 of the image encoding apparatus selects a weighted prediction parameter exhibiting the optimum coding efficiency from the plurality of weighted prediction parameters in step S702.

When image transformer 113 transforms by applying multiple sizes of transform units and thereby the weight calculator 114 generates a plurality of weighted prediction parameters, the parameter determiner 117 selects a weighted prediction parameter exhibiting the optimum coding efficiency from the plurality of weighted prediction parameters.

In this case, weight information including the weighted prediction parameters further includes information on the transform selected by the parameter determiner 117 for the purpose of generating the selected weighting prediction parameter. For example, it is information for identifying the size of the transform or the transform algorithm (DCT, DST or the like).

Further, after step S702 calculated a first weighted prediction parameter applicable to the current picture, the parameter determiner 117 determines the coding efficiency for each coding unit and thereby determines whether to perform a weighted prediction using the first weighted prediction parameter or not. At this time, the criteria utilized for determining the encoding efficiency can be rate-distortion cost (RDcost), sum squared distortion (SSD), sum absolute distortion (SAD) or the like.

After determining for each coding unit whether to perform the weighted prediction using the first weighted prediction parameter, a second weighted prediction parameter is calculated by using only the pixels of coding units which are determined to undergo the weighted prediction. The method for calculating the second weighted prediction parameter herein is any one of methods for calculating the first weighted prediction parameter.

Upon calculating the second weighted prediction parameter, an optimal weighted prediction parameter is determined for each picture by selecting one with less coding cost between the first and second weighted prediction parameters.

When the first weighted prediction parameter is selected here, predicted blocks are generated by using the first weighted prediction parameter for coding units determined to apply the weighted prediction. In the contrary, in case of coding units determined not to apply the weighted prediction, predicted blocks are generated without the weighted prediction.

If the second weight prediction parameter is selected as the optimal weighting prediction parameter, a third weighted prediction parameter is calculated in the same method as that used for calculating the second weighted prediction parameter. Specifically, coding efficiency is determined for each of the coding units in the current picture to determine whether to perform the weighted prediction by use of the second weighted prediction parameter or to generate predicted blocks without using a weighted prediction parameter.

After determining for each coding unit whether to perform the weighted prediction using the second weighted prediction parameter, the third weighted prediction parameter is calculated by using only the pixels of the coding units which are determined to undergo the weighted prediction by use of the second weighted prediction parameter. The method for calculating the third weighted prediction parameter herein is any one of methods for calculating the first weighted prediction parameter.

Upon calculating the third weighted prediction parameter, an optimal weighted prediction parameter is determined for each picture between the second and third weighted prediction parameters by choosing one with less coding cost.

When the second weighted prediction parameter is selected here, predicted blocks are generated by using the second weighted prediction parameter for the coding units determined to perform the weighted prediction by use of the second weighted prediction parameter. In the contrary, in case of coding units determined not to not to apply the weighted prediction, predicted blocks are generated without the weighted prediction.

If the third weight prediction parameter is selected as the optimal weighting prediction parameter, a fourth weighted prediction parameter is calculated in the same method as that used for calculating the third weighted prediction parameter. In this manner, additional weighted prediction parameters are generated sequencially and repeatedly. In the process, if a previously generated weighted prediction parameter is determined to exhibit better coding efficiency than the newly generated parameter, the previous parameter is determined as the weighted prediction parameter for use in generating the predicted blocks.

In addition, the image encoding apparatus encodes a weighted prediction flag indicating whether to apply the weighted prediction parameter for each coding unit, further incorporates the flag in the weight information inclusive of the weighted prediction parameter into a bitstream and transmits the bitstream to an image decoding apparatus to be described below. In response to the weighted prediction flag included in the bitstream, the image decoding apparatus performs weighted prediction for each coding unit. The weighted prediction flag indicates whether the corresponding coding unit underwent the weighted prediction or not.

When, for example, performing the weighted prediction by use of transform as in FIG. 6, the weighted prediction flag can be encoded/decoded in M×N transform (block) units.

When performing the weighted prediction with transform as in FIG. 6, the first weighted prediction parameter is calculated by using DCT 8×8, and the second weighted prediction parameter is calculated by using DST 8×8 to choose an optimal one of the two parameters. At this time, an encoder encodes transform information into the header. The information is meant to be the size of transform, the type of transform or both.

At the stage of applying the weighted prediction parameter, the optimal weighted prediction parameter is applied from the aforementioned step of determining the weighted prediction parameter.

At the stage of applying the weighted prediction parameter, the weight applicator 115 applies, to the second transformed picture, weighted prediction parameters calculated in the predetermined transform unit so as to generate weighted transformed images (e.g. weighted transformed picture).

In addition, referring to FIG. 6, when calculating weighted prediction parameters in transform domain, the weighted prediction flag can be encoded/decoded in the M×N transform units rather than coding unit or prediction unit. For example, if the coding efficiency is high with the weighted prediction, weighted predictive encoding is performed and the weighted prediction flag indicating the weighted prediction is transmitted to the video decoding apparatus. However, if the weighted prediction provides a low encoding efficiency, encoding is performed without the weighted prediction and a weighted prediction flag indicating usual prediction instead of the weighted prediction is transmitted to the video decoding apparatus.

On the other hand, to perform the weighted prediction, it is necessary to encode/decode the offset factor and scale factor. In case of performing the weighted prediction by the methods of FIGS. 4, 5 and 7, ‘w’ and ‘o’ are encoded/decoded into arbitrary headers, that is, headers of data corresponding to the unit of the weighted prediction such as headers of, for example, slice, picture, sequence or the like. In case of using the method of FIG. 6, M×N ‘w’s and an ‘o’s are encoded/decoded into the headers of the corresponding data. Alternatively, M×N ‘w’s and a single ‘o’ for low-frequency coefficient are encoded/decoded into the headers.

In this case, considering that a large M×N block costs a large amount of bits for encoding the weighted prediction parameter to reduce the encoding efficiency, ‘w’ and ‘o’ are predicted or sampled before the encoding.

For example, if the current slice encodes M×N ‘w’s and one ‘o’ number, the M×N ‘w’s are predictively encoded by using Equation 9 or Equation 10.

w_{Diff}(m,n)=w_{PrevSlice}(m,n)−w_{CurrSlice}(m,n) Equation 9

Here, w_{Diff}(m,n) is a value for encoding as well as a differential scale factor at position (m, n) in a M×N transformed block, w_{PrevSlice}(m,n) is the scale factor at position (m, n) in the M×N transformed block of the previous slice, and w_{CurrSlice}(m,n) denotes the scale factor at position (m, n) in the M×N transformed block of the current slice.

Therefore, it can be seen from Equation 9 that the weight information includes weighted parameter information in the form of differential values against the weighted parameters of a set of previous blocks.

w_{Diff}(0,0)=2^{q}−w_{CurrSlice}(0,0)

w_{Diff}(m,0)=w_{CurrSlice}(m−1,0)−w_{CurrSlice}(m,0)(m≠0)

w_{Diff}(m,0)=w_{CurrSlice}(m,n−1)−w_{CurrSlice}(m,n)(n≠0) Equation 10

wherein 2^{q} is a predicted value with q bits-value.

According to Equation 10, the weight information includes differential values generated with a predetermined value (e.g., the maximum value that the weighted prediction parameter can have, i.e. 2^{q}) for direct current (DC) image components, and includes differential values generated against weighted prediction parameter of nearby frequency components for the remaining non-DC image components.

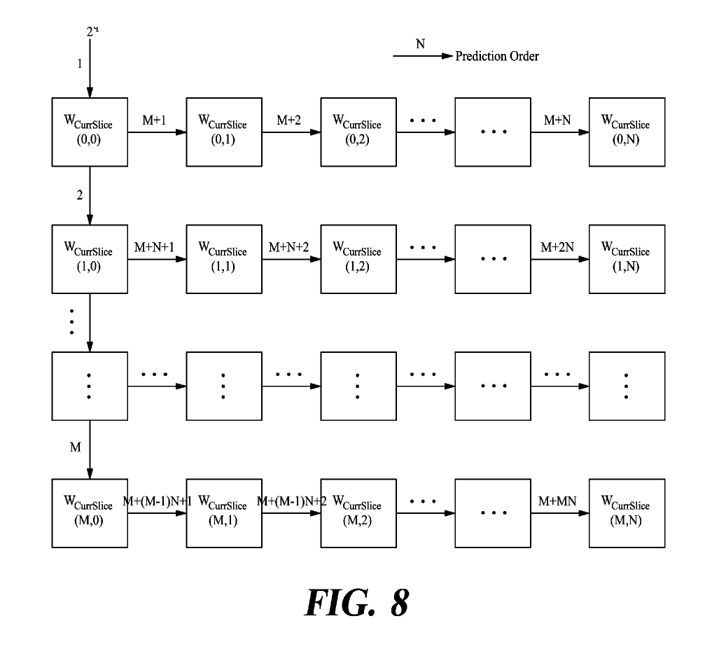

FIG. 8 is a schematic diagram of a method for obtaining a weighted parameter according to Equation 10.

As illustrated in FIG. 8, w_{Diff}(0,0) is subtracted by w_{CurrSlice}(1,0) to obtain w_{Diff}(1,0). In turn, w_{Diff}(1,0) is subtracted by w_{CurrSlice}(2,0) to obtain w_{Diff}(2,0), whereby obtaining w_{Diff}(m,0). Thereafter, w_{Diff}(0,0) is subtracted by w_{CurrSlice}(0,1) to obtain w_{Diff}(0,1). In turn, w_{Diff}(0,1) is subtracted by w_{CurrSlice}(0,2) to obtain w_{Diff}(0,2) and thereby w_{Diff}(0,n) can be obtained.

Equation 11 is for calculating w_{Diff} of the 4×4 transformed block when using the method of FIG. 8. It is equally applicable to the M×N size.

$$[ \begin{matrix}{w}_{diff} ( 0 , 0 ) & {w}_{diff} ( 0 , 1 ) & {w}_{diff} ( 0 , 2 ) & {w}_{diff} ( 0 , 3 ) \\ {w}_{diff} ( 1 , 0 ) & {w}_{diff} ( 1 , 1 ) & {w}_{diff} ( 1 , 2 ) & {w}_{diff} ( 1 , 3 ) \\ {w}_{diff} ( 2 , 0 ) & {w}_{diff} ( 2 , 1 ) & {w}_{diff} ( 2 , 2 ) & {w}_{diff} ( 2 , 3 ) \\ {w}_{diff} ( 3 , 0 ) & {w}_{diff} ( 3 , 1 ) & {w}_{diff} ( 3 , 2 ) & {w}_{diff} ( 3 , 3 )\end{matrix} ] \qquad Equation 11$$

Equation 11 can be rewritten as Equation 12.

$$= [ \begin{matrix}{2}^{q} & {w}_{currSlice} ( 0 , 0 ) & {w}_{currSlice} ( 0 , 1 ) & {w}_{currSlice} ( 0 , 2 ) \\ {w}_{currSlice} ( 0 , 0 ) & {w}_{currSlice} ( 1 , 0 ) & {w}_{currSlice} ( 1 , 1 ) & {w}_{currSlice} ( 1 , 2 ) \\ {w}_{currSlice} ( 1 , 0 ) & {w}_{currSlice} ( 2 , 0 ) & {w}_{currSlice} ( 2 , 1 ) & {w}_{currSlice} ( 2 , 2 ) \\ {w}_{currSlice} ( 2 , 0 ) & {w}_{currSlice} ( 3 , 0 ) & {w}_{currSlice} ( 3 , 1 ) & {w}_{currSlice} ( 3 , 2 )\end{matrix} ] - \\ [ \begin{matrix}{w}_{currSlice} ( 0 , 0 ) & {w}_{currSlice} ( 0 , 1 ) & {w}_{currSlice} ( 0 , 2 ) & {w}_{currSlice} ( 0 , 3 ) \\ {w}_{currSlice} ( 1 , 0 ) & {w}_{currSlice} ( 1 , 1 ) & {w}_{currSlice} ( 1 , 2 ) & {w}_{currSlice} ( 1 , 3 ) \\ {w}_{currSlice} ( 2 , 0 ) & {w}_{currSlice} ( 2 , 1 ) & {w}_{currSlice} ( 2 , 2 ) & {w}_{currSlice} ( 2 , 3 ) \\ {w}_{currSlice} ( 3 , 0 ) & {w}_{currSlice} ( 3 , 1 ) & {w}_{currSlice} ( 3 , 2 ) & {w}_{currSlice} ( 3 , 3 )\end{matrix} ] \qquad Equation 12$$

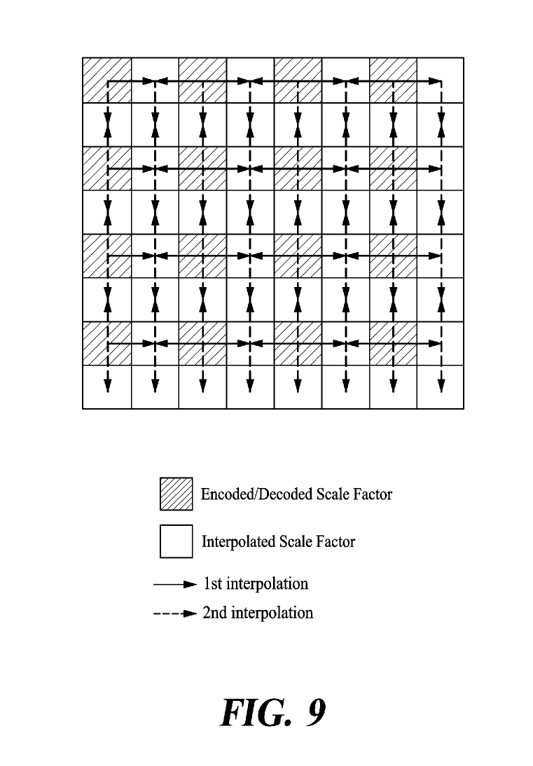

FIG. 9 is an exemplary diagram illustrating frequency component weighted prediction parameters generated for the respective frequency components at predetermined intervals.

Sampling and then encoding/decoding M×N weighted prediction parameters are performed by referring to FIG. 9.

In other words, weighted prediction parameter generated for a predetermined transform unit is a frequency component weighted prediction parameter for each of frequency components at predetermined intervals, and the intervening frequency component weighted prediction parameter therebetween are provided by use of interpolated values.

Referring to FIG. 9, the weight information to be encoded includes weighted prediction parameters at the locations of hatched blocks, and weighted prediction parameters at blank (non-hatched) blocks are obtained from interpolations with nearby weighted prediction parameters.

Image inverse transformer 116 inversely transforms a weighted transformed picture to generate a weighted predicted image (e.g., weighted predicted picture).

The subtractor 116 subtracts, from the current block, a predicted block in the weighted predicted image to generate a residual block of the current coding unit.

The residual block generated in this way is processed through the transformer 104 and quantizer 105, and is encoded in the entropy encoder 107.

The transformer 104 generates transform blocks corresponding to the one or more transform units, by transforming the residual block in the transform units. Transform units are divided from the coding unit by using a quad-tree structure as illustrated in FIG. 2, or variably divided before being transformed. Herein, the transform units may have various sizes within the coding unit based on the used quad-tree. The transformer 104 transforms the residual signals into frequency domain to generate and output the transform blocks having transform coefficients. Here, the transforming of the residual signals into the frequency domain uses various transform methods such as discrete cosine transform (DCT), discrete sine transform (DST) and Karhunen Loeve transform (KLT) which can transform the residual signals into the frequency domain and then into the transform coefficients. To facilitate the use of the transform techniques, a base vector is used for matrix operation in which various transform techniques are used depending on the specific encoding method applied. For example, when performing an intra prediction, DCT is used in the horizontal prediction direction and DST is used in the vertical prediction direction.

The quantizer 105 quantizes the transform blocks upon receiving the same from the transformer 104, so as to generate quantized transform blocks. In other words, the quantizer 105 generates and outputs the quantized transform blocks with quantized transform coefficients by quantizing the transform coefficients of the transform blocks output from the transformer 104. Here, the quantizing uses a dead zone uniform threshold quantization (DZUTQ), quantization weighted matrix or the like, although their various improvements are used among others.

The entropy encoder 107 generates the bitstream by encoding the quantized transform block. In other words, by using various encoding schemes such as entropy encoding, the entropy encoder 107 encodes the frequency coefficient string generated from scanning the quantized transform coefficients in various scanning methods such as zig-zag scanning, and generates a bitstream including additional information (e.g. prediction mode information, quantized coefficients, motion parameters, information on quad-tree partitioning of the largest coding unit, information on quad-tree partitioning of a coding unit into one or more transform units, etc.) which the video decoding apparatus described below uses for decoding the corresponding block.

The inverse quantizer 108 inversely quantizes the quantized transform blocks to reconstruct transform blocks with transformed coefficients.

The inverse transformer 109 inversely transforms the transform blocks, and reconstructs a residual block of the current coding unit by merging the inversely transformed transform blocks.

The adder 112 sums the reconstructed residual block and the predicted block generated through intra prediction or inter prediction to reconstruct the current coding block.

The memory 110 saves the reconstructed current coding block so that it is used to predict other blocks such as the subsequent block or subsequent picture.

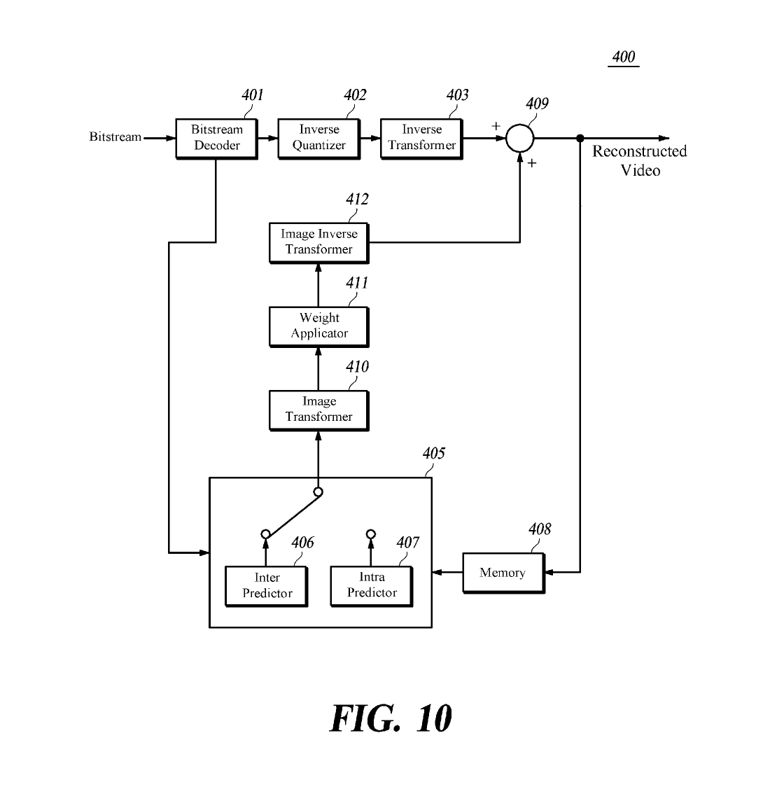

FIG. 10 is a schematic diagram of a video decoding apparatus according to at least one embodiment of the present disclosure.

The video decoding apparatus 400 in at least one embodiment comprises a bitstream decoder 401, an inverse quantizer 402, an inverse transformer 403, a predictor 405, an adder 409, and a memory 408. The video decoding apparatus 400 further comprises an image transformer 410, a weight applicator 411 and an image inverse transformer 412. All or some components of the video decoding apparatus 400, such as the bitstream decoder 401, the inverse quantizer 402, the inverse transformer 403, the predictor 405, and the adder 409 are implemented by one or more processors and/or application-specific integrated circuits (ASICs).

The bitstream decoder 401 extracts, from the bitstream, one or more quantized transform blocks within the current coding unit and weight information. Herein, the current coding unit is obtained by recursively partitioning the largest coding unit in a quad-tree structure based on information on quad-tree partitioning of the largest coding unit included in the bitstream. The bitstream decoder 401 identifies one or more transform blocks recursively divided in a quad-tree structure from the current coding unit based on information on quad-tree partitioning of the coding unit into one or more transform units, which is included in the bitstream, and performs a decoding and reverse scanning on the bit string extracted from the input bitstream to reconstruct the quantized transform blocks corresponding to the transform units. At this time, the bitstream decoder 401 performs the decoding by using the same technique of entropy encoding as used by the entropy encoder 107. Further, in case of inter prediction, the bitstream decoder 401 extracts and decodes, from the bitstream, information on the encoded differential motion vector and the motion parameters to thereby reconstruct the motion vectors of the prediction units within the current coding unit. In case of intra prediction, it extracts and decodes an intra prediction mode information from the bitstream to indicate which intra prediction mode the prediction units have used. In addition, the bitstream decoder 401 extracts and decodes a weighted prediction flag from the bitstream, and then decodes, from the bitstream, a weighted prediction parameter applicable to each of the prediction units within the current coding unit when the decoded weighted prediction flag indicates that the weighted prediction is performed.

The inverse quantizer 402 inversely quantizes the quantized transform blocks. In particular, the inverse quantizer 402 inversely quantizes the quantized transform coefficients of the quantized transform blocks outputted from the bitstream decoder 401. In this case, the inverse quantizer 402 performs its inverse quantization by reversing the quantization procedure utilized by the quantizer 105 of the video encoding apparatus.

The inverse transformer 403 reconstructs a residual block of the current coding unit by inversely transforming the inversely quantized transform blocks outputted from the inverse quantizer 402 and merging the inversely transformed transform blocks. Specifically, the inverse transformer 403 reconstructs the residual block by inversely transforming the inversely quantized transform coefficients of the inversely quantized transform blocks outputted from the inverse quantizer 402, wherein the inversely transforming is achieved by reversing the transform procedure utilized by the transformer 104 of the video encoding apparatus.

The predictor 405 comprises an inter predictor 406 and an intra predictor 407 which operate similar to the intra predictor 102 and inter predictor 103 of the aforementioned video encoding apparatus. The inter predictor 407 generates a predicted block of the current coding unit by predicting the prediction units using the reconstructed motion vectors of the prediction units within the current coding unit. If the weighted prediction flag extracted from the bitstream indicates that the weighted prediction is applied, the inter predictor 407 generates the predicted block of the current coding unit by applying a corresponding weighted prediction parameter to each of the predicted prediction units. If the weighted prediction flag indicates that the weighted prediction is not applied, the inter predictor 407 generates the predicted block without performing the weighted prediction.

In addition, for performing the weighted prediction using a transform, the video decoding apparatus 400 further comprises the image transformer 410, the weight applicator 411 and the image inverse transformer 412. The image transformer 410 generates a first transformed image by transforming a set of blocks including the current block in predetermined units of transform and generates a second transformed image by transforming a motion compensated predicted image formed of predicted blocks of the set of blocks, in predetermined units of transform.

The weight applicator 411 applies a weighted predicted parameter included in the reconstructed weight information to the second transformed image in the predetermined units of transform and thereby generates a weighted transformed image. The method for generating the weighted transformed image by applying the weighted predicted parameter is similar to the method performed by the weight applicator 115 of the video encoding apparatus.

The image inverse transformer 412 generates a weighted predicted image by inversely transforming the weighted transformed image. The method for generating the weighted predicted image by inversely transforming the weighted transformed image is similar to the method performed by the image inverse transformer 116 of the video encoding apparatus.

The adder 409 adds the predicted block outputted from the predictor 405 and the reconstructed residual block to reconstruct the current coding unit.

The memory 408 works similar to the memory 110 of the video encoding apparatus by saving the decoded image for use in the subsequent prediction.

Meanwhile, the video encoding/decoding apparatus according to at least one embodiment of the present disclosure can be implemented by connecting the output terminal of bitstream (encoded data) of the video encoding apparatus of FIG. 1 to the bitstream input terminal of the video decoding apparatus of FIG. 10.

The video encoding/decoding apparatus according to at least one embodiment comprises the video encoding apparatus 100 and video decoding apparatus 800 which respectively implement a video encoder and a video decoder of the video encoding/decoding apparatus according to at least one embodiment. The video encoding apparatus 100 is configured to generate a first predicted block of the current block corresponding to the current coding unit; transform a set of blocks including the current block by a predetermined transform unit to generate a first transformed image; transform a motion compensated predicted image formed of predicted blocks of the set of blocks, by the predetermined transform unit, to generate a second transformed image; calculate a weighted predicted parameter for each predetermined transform unit co-located in the first and second transformed images, based on a relationship between transform coefficients of the first and second transformed images; apply to the second transformed image the weighted predicted parameters by the predetermined transform unit to generate a weighted transformed image; inversely transform the weighted transformed image to generate a weighted predicted image; subtract a predicted block in the weighted predicted image from the current block to generate a residual block; and thereby encode the current block into a bitstream. The video decoding apparatus 800 is configured to decode quantized transform blocks of the current block and weight information from a bitstream; generate a predicted block of the current block; transform a set of blocks including the current block by a predetermined transform unit to generate a first transformed image; transform a motion compensated predicted image formed of predicted blocks of the set of blocks, by the predetermined transform unit, to generate a second transformed image; apply to the second transformed image the weighted predicted parameters included in the weight information by the predetermined transform unit to generate a weighted transformed image; inversely transform the weighted transformed image to generate a weighted predicted image; and add a predicted block in the weighted predicted image and a reconstructed residual block to reconstruct the current block.

A video encoding method according to at least one embodiment comprises: performing a prediction by generating a first predicted block of a current block; image-transforming comprising transforming a set of blocks including the current block by a predetermined transform unit to generate a first transformed image, and transforming a motion compensated predicted image formed of predicted blocks of the set of blocks, by the predetermined transform unit, to generate a second transformed image; calculating a weighted predicted parameter for each predetermined transform unit co-located in the first and second transformed images, based on a relationship between transform coefficients of the first and second transformed images; applying to the second transformed image the weighted predicted parameters by the predetermined transform unit to generate a weighted transformed image; inversely transforming the weighted transformed image to generate a weighted predicted image; subtracting a predicted block in the weighted predicted image from the current block to generate a residual block; transforming the residual block to generate one or more transform blocks; quantizing the transform blocks to generate quantized transform blocks; and performing an entropy encoding by encoding weight information including the weighted predicted parameters and the quantized frequency transform blocks into a bitstream.

Here, detailed descriptions of the respective processes are omitted since the performing of the prediction corresponds to the operation of the predictor 106, the image transforming to the operation of the image transformer 113, the calculating of the weighted predicted parameter to the operation of the weight calculator 114, the applying of the weighted predicted parameters to the operation of the weight applicator 115, the inversely transforming to the operation of the image inverse transformer 116, the subtracting to the operation of the subtractor 111, the transforming to the operation of the transformer 104, the quantizing to the operation of the quantizer 105, and the performing of the entropy encoding to the operation of the entropy encoder 107.

A video decoding method according to at least one embodiment comprises: bitstream decoding comprising decoding one or more quantized transform blocks and weight information from a bitstream; inversely quantizing the quantized transform blocks to generate transform blocks; inversely transforming the transform blocks to reconstruct a residual block of a current block; performing a prediction to generate a predicted block of the current block; image transforming comprising transforming a set of blocks including the current block by a predetermined transform unit to generate a first transformed image, and transforming a motion compensated predicted image formed of predicted blocks of the set of blocks, by the predetermined transform unit to generate a second transformed image; applying to the second transformed image the weighted predicted parameters included in the weight information by the predetermined transform unit to generate a weighted transformed image; inversely transforming the weighted transformed image to generate a weighted predicted image; and adding a predicted block in the weighted predicted image and the reconstructed residual block to reconstruct the current block.

Here, detailed descriptions of the respective processes are omitted since the bitstream decoding corresponds to the operation of the bitstream decoder 401, the inversely quantizing corresponds to the operation of the inverse quantizer 402, the inversely transforming corresponds to the operation of the inverse transformer 403, the performing the prediction corresponds to the operation of the predictor 405, the image transforming corresponds to the operation of the image transformer 410, the applying of the weighted predicted parameters corresponds to the operation of the weight applicator 411, the inversely transforming corresponds to the operation of the image inverse transformer 412, and the summing corresponds to the operation of the adder 409.

The video encoding/decoding method according to an exemplary embodiment of the present disclosure is implemented by combining the video encoding method according to an exemplary embodiment of the present disclosure and a video decoding method according to an exemplary embodiment of the present disclosure.

A video encoding/decoding method according to at least one embodiment comprises encoding a video and decoding a video decoding. The encoding of the video comprises: generating a first predicted block of a current block corresponding to the current coding unit; transforming a set of blocks including the current block by a predetermined transform unit to generate a first transformed image; transforming a motion compensated predicted image formed of predicted blocks of the set of blocks, by the predetermined transform unit to generate a second transformed image; calculating a weighted predicted parameter for each predetermined transform unit co-located in the first and second transformed images, based on a relationship between transform coefficients of the first and second transformed images; applying to the second transformed image the weighted predicted parameters by the predetermined transform unit to generate a weighted transformed image; inversely transforming the weighted transformed image to generate a weighted predicted image; subtracting a predicted block in the weighted predicted image from the current block to generate a residual block; and thereby encoding the current block into a bitstream. The decoding of the video comprises: decoding one or more quantized frequency transform blocks within the current coding unit and weight information from a bitstream; performing a prediction to generate a predicted block of a current block to be reconstruct; transforming a set of blocks including the current block by a predetermined transform unit to generate a first transformed image; transforming a motion compensated predicted image formed of predicted blocks of the set of blocks, by the predetermined transform unit to generate a second transformed image; applying to the second transformed image the weighted predicted parameters included in the weight information by the predetermined transform unit to generate a weighted transformed image; inversely transforming the weighted transformed image to generate a weighted predicted image; and adding a predicted block in the weighted predicted image and a reconstructed residual block to reconstruct the current block.

In the description above, although all of the components of the embodiments of the present disclosure have been explained as assembled or operatively connected as a unit, one of ordinary skill would understand the present disclosure is not limited to such embodiments. Rather, within some embodiments of the present disclosure, the respective components are selectively and operatively combined in any number of ways. Every one of the components are capable of being implemented alone in hardware or combined in part or as a whole and implemented in the form of one or more computer programs having program modules residing in non-transitory computer readable media and causing a processor or microprocessor to execute functions of the hardware equivalents. Codes or code segments to constitute such a program are understood by a person skilled in the art. The computer programs are stored in any non-transitory computer readable media, which in operation realizes the embodiments of the present disclosure. The non-transitory computer readable media includes a ROM, a RAM, a CD-ROM, a magnetic tape, a floppy disk, an optical data storage device, magnetic recording media, optical recording media and the like.

Although exemplary embodiments of the present disclosure have been described for illustrative purposes, those skilled in the art will appreciate that various modifications, additions and substitutions are possible, without departing from the scope of the disclosure. Therefore, exemplary embodiments of the present disclosure have been described for the sake of brevity and clarity. Accordingly, one of ordinary skill would understand the scope of the claimed invention is not limited by the explicitly described above embodiments but by the claims and equivalents thereof.

1. A method for decoding video images, the method comprising:
determining a coding block, from a bitstream, which is divided in a quadtree structure from a largest coding block;
decoding, from the bitstream, motion information on one or more prediction blocks divided from the coding block;
predicting the prediction blocks based on the motion information;
reconstructing a residual block from the bitstream; and
reconstructing the coding block by adding the predicted prediction blocks and the reconstructed residual block,
wherein the predicting of the prediction blocks comprises:
generating first predicted pixels within each of the prediction blocks by using the motion information;
decoding, from the bitstream, a weighted prediction parameter applicable to each of the prediction blocks; and
generating second predicted pixels within each of the prediction blocks by applying the weighted prediction parameter to the first predicted pixels within each of the prediction blocks.

2. The method of claim 1, wherein the decoding of the weighted prediction parameter includes decoding, from the bitstream, the weighted prediction parameter designated in a unit of slices within a picture.

3. The method of claim 1, wherein the weighted prediction parameter includes
(i) information on a scale factor to multiply the first predicted pixels within the prediction blocks, and
(ii) information on an offset factor to add to the first predicted pixels multiplied by the scale factor.

4. The method of claim 1, wherein a size of the coding block is determined to be a size ranging from a size of the largest coding block to a size of a smallest coding block.

5. The method of claim 1, wherein the coding block is divided into the one or more prediction blocks by one among a plurality of partition types including a partition type in which the coding block is divided into two rectangular blocks asymmetric in size.

6. The method of claim 1, wherein the reconstructing of the residual block comprises:
identifying one or more transform blocks partitioned in a second quadtree structure from the coding block;
inversely quantizing and inversely transforming each of the transform blocks; and
constructing the residual block by merging the inversely quantized and inversely transformed transform blocks.

7. The method of claim 6, wherein respective sizes of the transform blocks are determined variably based on the second quadtree within the coding unit.

8. The method of claim 1, further comprising:
decoding a weighted prediction flag from the bitstream,
wherein the decoding of the weighted prediction parameter and the generation of the second predicted pixels is performed when the decoded weighted prediction flag indicates that a weighted prediction is applied on the prediction blocks.

9. The method of claim 8, wherein the weighted prediction flag is included in the bitstream in a unit of pictures.
